(19) United States
(12) Patent Application Publication
(10) Pub. No.: US 2015/0162681 A1
(43) Pub. Date: Jun. 11, 2015

(54) CARD CONNECTOR

(71) Applicant: Cheng Uei Precision Industry Co., Ltd., New Taipei City (TW)

(72) Inventors: KUO WEI CHEN, New Taipei City (TW); SHENG NAN YU, New Taipei City (TW); KUO-CHIN LIN, New Taipei City (TW)

(73) Assignee: Cheng Uei Precision Industry Co., Ltd., New Taipei City (TW)

(21) Appl. No.: 14/103,835

(22) Filed: Dec. 11, 2013

(51) Int. Cl. H01R 12/72; H01R 13/629

(52) U.S. Cl. CPC H01R 12/72; H01R 13/62911

(57) ABSTRACT

A card connector includes an insulating housing, a plurality of conductive terminals, at least one ejection mechanism, at least one reset mechanism, a shielding shell and a card tray. The reset mechanism is disposed to a front of the insulating housing with a base portion located at a front thereof elastically projecting beyond a front surface of the insulating housing. The card tray slidably disposed to the insulating housing includes a base board, and a cover portion protruded forward and then spread outward from a front end of the base board and projecting beyond the front end of the base board. The front surface of the base portion of the reset mechanism abuts against a rear surface of an enclosure of the electronic device so as to make a front surface of the cover portion be flush with an outer surface of the electronic device.

### BACKGROUND OF THE INVENTION

1. Field of the Invention

The present invention generally relates to a connector, and more particularly to a card connector.

2. The Related Art

A conventional card connector is adapted for being assembled in an electronic device which includes a circuit board and an enclosure, and being communicated between an electronic card and the circuit board of the electronic device. The enclosure defines an opening. The card connector includes an insulating housing, a plurality of conductive terminals received in the insulating housing for cooperating with the electronic card, an ejection mechanism disposed to one side of the insulating housing, a card tray for receiving the electronic card therein, and a shielding shell covered on the insulating housing to form an insertion space between the insulating housing and the shielding shell. The ejection mechanism includes a push rod and an executing element which is pushed against by the push rod. The card tray includes a base board with a receiving space being formed therein and a cover portion connecting with a front end of the base board. One side of the cover portion defines a through-hole. The card tray is slidably disposed to the insertion space of the card connector. The card connector is mounted to the circuit board of the electronic device.

When the electronic card needs to be inserted in the card connector, the electronic card is placed in the receiving space of the card tray, and then the card tray together with the electronic card is pushed into the insertion space of card connector through the opening. When the electronic card needs to be withdrawn from the card connector, the push rod passes through the through-hole of the cover portion of the card tray to push against the executing element to eject the card tray together with the electronic card out of the card connector.

However, the card connector is hardly to be mounted to the circuit board of the electronic device to a proper position that results in an outer surface of the cover portion of the card tray unable to be flush with an outer surface of the enclosure of the electronic device. Therefore, it seriously affects an appearance of the electronic device.

### SUMMARY OF THE INVENTION

An object of the present invention is to provide a card connector adapted for being assembled in an electronic device which includes a circuit board and an enclosure, and being communicated between an electronic card and the circuit board, the enclosure defines an opening. The card connector includes an insulating housing, a plurality of conductive terminals of which each integrally molded to the bottom wall of the insulating housing with a contact portion thereof defined at a top thereof projecting beyond the bottom wall to electrically contact with the electronic card and a soldering portion defined at a rear thereof projecting under the bottom wall to be soldered on the circuit board, at least one ejection mechanism, at least one reset mechanism, a shielding shell and a card tray. The insulating housing has a bottom wall, a first side wall and a second side wall extending upward from two opposite sides of the bottom wall, and a rear wall extending upward from a rear end of the bottom wall and connecting with the first side wall and the second side wall. The ejection mechanism is slidably disposed to one side of the insulating housing. The ejection mechanism includes a sliding block which includes a base body of which a portion slidably disposed on the bottom wall of the insulating housing, a first elastic element restrained between the base body of the sliding block and the rear wall of the insulating housing, and a guiding element of which one end is fastened in the sliding block and the other end is slidably located in a front of one side of the insulating housing. The sliding block has a blocking portion extended sideward from a rear end of one side of the base body, and a pushing portion extended sideward from a rear end of an outer side surface of the blocking portion, the blocking portion and the pushing portion being disposed on the bottom wall of the insulating housing. The reset mechanism is disposed to a front of the insulating housing with a base portion located at a front thereof elastically projecting beyond a front surface of the insulating housing. The shielding shell is covered on the insulating housing to form an insertion space between the insulating housing and the shielding shell for receiving the electronic card therein. The card tray is slidably disposed to the insulating housing from the opening of the electronic device. The card tray for receiving the electronic card therein includes a base board, and a cover portion protruded forward and then spread outward from a front end of the base board and projecting beyond the front end of the base board. The cover portion is corresponding to the opening of the electronic device. When the card connector is mounted to the circuit board of the electronic device to be assembled in the electronic device to a proper position, a front surface of the base portion of the reset mechanism abuts against a rear surface of the enclosure of the electronic device so as to make a front surface of the cover portion of the card tray be flush with an outer surface of the electronic device.

As described above, the card connector includes at least one reset mechanism which includes the base portion located at the front thereof elastically projecting beyond the front surface of the insulating housing, when the card connector is mounted to the circuit board of the electronic device to be assembled in the electronic device to the proper position, the front surface of the base portion abuts against the rear surface of the enclosure of the electronic device so as to make the front surface of the cover portion of the card tray be flush with the outer surface of the electronic device. Therefore, it effectively improves an appearance of the electronic device.

### BRIEF DESCRIPTION OF THE DRAWINGS

The present invention will be apparent to those skilled in the art by reading the following description, with reference to the attached drawings, in which:

FIG. 1 is a perspective view of a card connector in accordance with an embodiment of the present invention;

FIG. 2 is an exploded view of the card connector of FIG. 1;

FIG. 3 is a perspective view of a sliding block of the card connector of FIG. 2;

FIG. 4 is a perspective view showing a status of a process of an electronic card being inserted in the card connector of FIG. 1;

FIG. 5 is a perspective view showing a status of the electronic card being completed being inserted in the card connector of FIG. 1; and

FIG. 6 is a perspective view showing a status of the electronic card being withdrawn from the card connector of FIG. 1.

### DETAILED DESCRIPTION OF THE PREFERRED EMBODIMENT

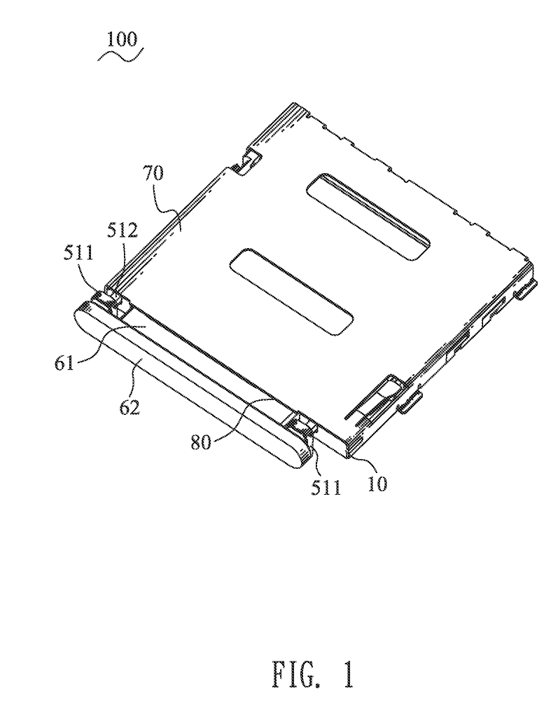

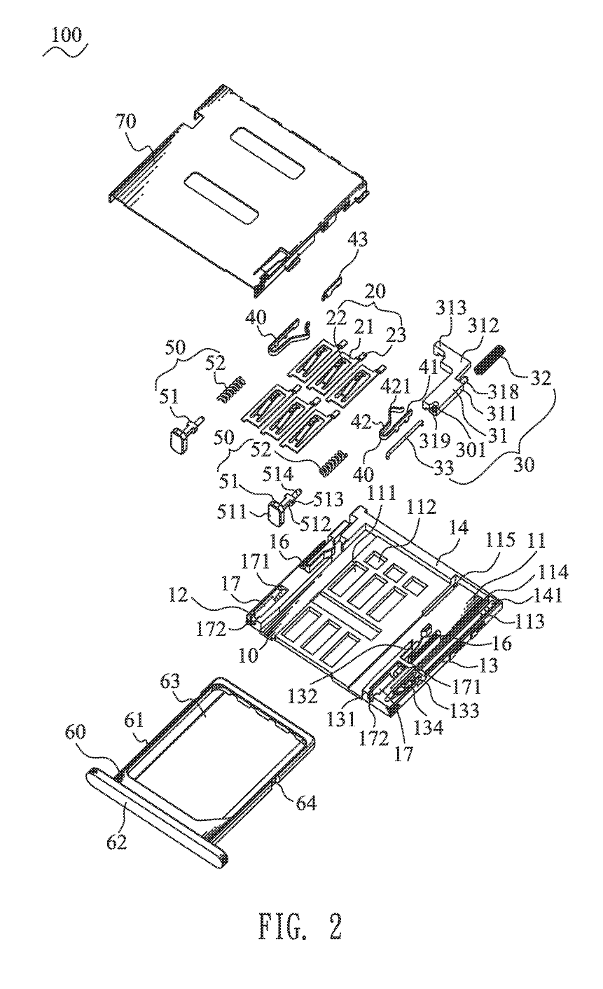

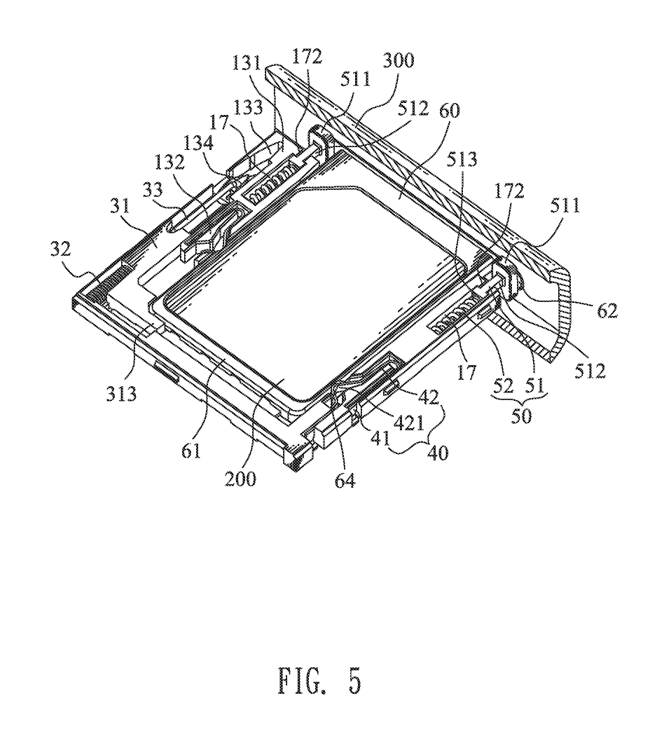

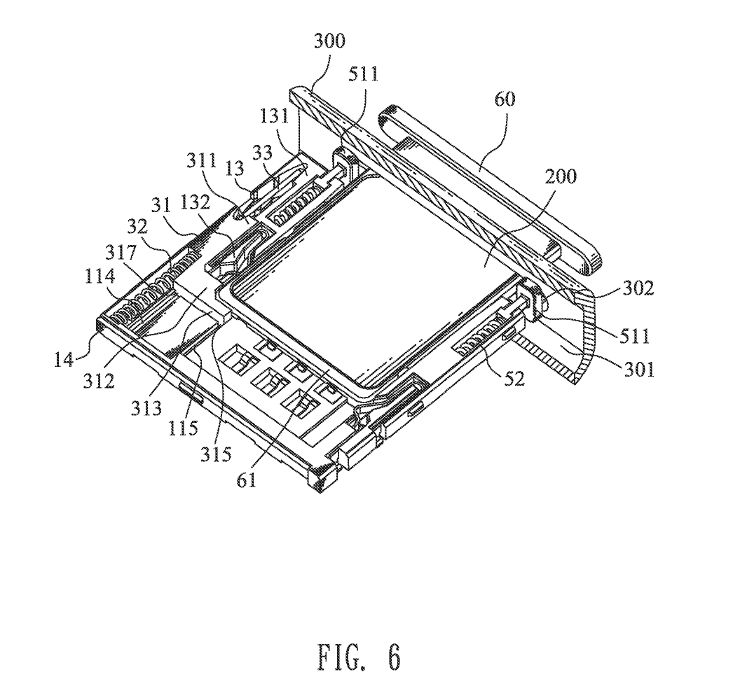

With reference to FIG. 1, FIG. 2, FIG. 5 and FIG. 6, a card connector 100 in accordance with an embodiment of the present invention is shown. The card connector 100 is adapted for being assembled in an electronic device 300 which includes a circuit board (not shown) and an enclosure 301, and being communicated between an electronic card 200 and the circuit board of the electronic device 300. The enclosure 301 defines an opening 302. The card connector 100 includes an insulating housing 10, a plurality of conductive terminals 20, at least one ejection mechanism 30, two elastic components 40, a switch terminal 43, at least one reset mechanism 50, a card tray 60 and a shielding shell 70.

Referring to FIG. 2, the insulating housing 10 has a bottom wall 11 of a substantial rectangular shape, a first side wall 12 and a second side wall 13 extending upward from two opposite sides of the bottom wall 11, and a rear wall 14 extending upward from a rear end of the bottom wall 11 and connecting with the first side wall 12 and the second side wall 13. The bottom wall 11 defines a plurality of first terminal holes 111 vertically penetrating therethrough and transversely arranged in two rows and a plurality of second terminal holes 112 vertically penetrating therethrough and transversely arranged in two rows. Each row of the second terminal holes 112 is spaced from and located in rear of one of the rows of the first terminal holes 111.

Referring to FIG. 2, a front end of one side of a top surface of the bottom wall 11 of the insulating housing 10 protrudes upward to form a first protruding block 131 adjacent to the second side wall 13 and away from the first terminal holes 111 and the second terminal holes 112. One side of a rear surface of the first protruding block 131 away from the second side wall 13 protrudes rearward to form a rectangular second protruding block 132. One side of the first protruding block 131 adjacent to the second side wall 13 defines a substantially heart-shaped tracking groove 133 joined end to end. A heart-shaped locking portion 134 is formed in the tracking groove 133 and is located apart from a periphery inside of the tracking groove 133. The insulating housing 10 define two lying U-shaped fastening groove 16 of which one penetrates through a top surface, two portions of an outer surface and an inner surface of the rear end of the first side wall 12, and the other one penetrates through a top surface, a rear surface and an inner side surface of the second protruding block 132. A front end of the top surface of the first side wall 12 of the insulating housing 10 and the other side of the first protruding block 131 away from the second side wall 13 are concaved inward to form two receiving troughs 17. A rear sidewall of the receiving trough 17 protrudes forward to form a first fastening pillar 171. Two middles of the two receiving troughs 17 extend forward to form two holding grooves 172 respectively passing through a front surface of the first side wall 12 of the insulating housing 10 and a front surface of the other side of the first protruding block 131 away from the second side wall 13. A bottom sidewall of the holding groove 172 shows an arc shape.

Two portions of a rear end of one side of the top surface of the bottom wall 11 of the insulating housing 10 are concaved downward to form a first guiding groove 113 adjacent to the second side wall 13 and a second guiding groove 114 adjacent to the second protruding block 132. The first guiding groove 113 and the second guiding groove 114 vertically penetrate therethrough and extend longitudinally between a rear surface of the first protruding block 131 and a front surface of the rear wall 14. Bottom sidewalls of the first guiding groove 113 and the second guiding groove 114 show arc shape. The front surface of the rear wall 14 protrudes forward to form a second fastening pillar 141 projecting into the first guiding groove 113. The bottom wall 11 of the insulating housing 10 defines a guiding hole 115 extending longitudinally and further passing through a front surface of the rear wall 14. The guiding hole 115 is adjacent to but spaced from the second protruding block 132.

Referring to FIG. 2, each of the conductive terminals 20 has a locating portion 21 of rectangular frame shape, a contact portion 22 slantwise extended upward and then arched upward from a front end of the locating portion 21, and a soldering portion 23 extended downward and then bent rearward from a rear end of the locating portion 21.

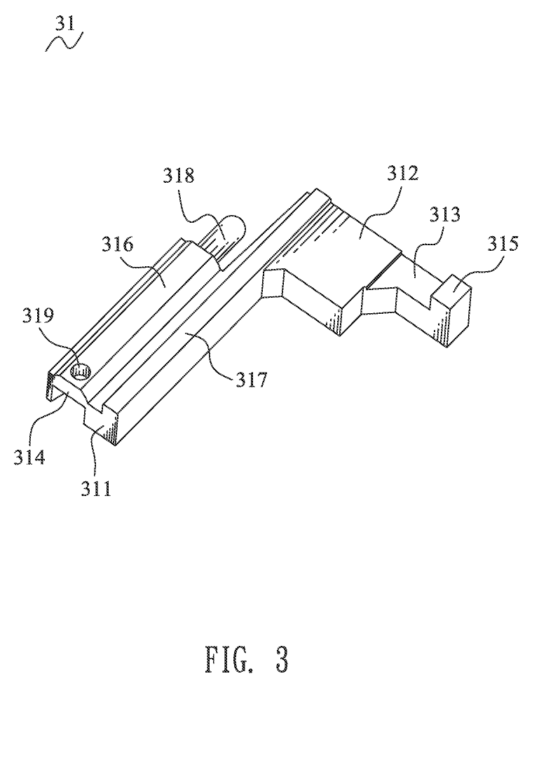

Referring to FIG. 2 and FIG. 3, the ejection mechanism 30 includes a sliding block 31, a first elastic element 32 and a guiding element 33. The sliding block 31 has a rectangular base body 311, a blocking portion 312 extended sideward from a rear end of one side of the base body 311, a pushing portion 313 extended sideward from a rear end of an outer side surface of the blocking portion 312, and an extending portion 314 extended opposite to the blocking portion 312 from a front end of the other side surface of the base body 311. A bottom surface of the pushing portion 313 protrudes downward to form a guiding block 315. A bottom surface of the extending portion 314 protrudes downward to form a first guiding rib 316. One side of a bottom surface of the base body 311 adjacent to the blocking portion 312 protrudes downward to form a second guiding rib 317. A rear surface of the extending portion 314 protrudes rearward to form a third fastening pillar 318. A front end of the base body 311 of the sliding block 31 defines a locating groove 301 penetrating through a top and a front thereof. A bottom sidewall of the locating groove 301 defines an insertion hole 319.

Referring to FIG. 2, the elastic component 40 has a fastening portion 41 and a resilient portion 42 arched forward and then extended rearward from a front end of the fastening portion 41. A middle of the resilient portion 42 is arched outward to form an arc-shaped clamping portion 421.

Referring to FIG. 2 again, in this embodiment, the card connector 100 includes two reset mechanisms 50. The reset mechanism 50 includes a resisting portion 51 and a second elastic element 52. The resisting portion 51 has a rectangular base portion 511, a movement portion 512 protruded rearward from a rear surface of the base portion 511 with a bottom surface of the movement portion 512 showing an arc surface, a limiting portion 513 protruded outward from two opposite side surfaces and a bottom surface of a rear end of the movement portion 512, and a fourth fastening pillar 514 protruded rearward from a rear surface of the movement portion 512.

Referring to FIG. 2, the card tray 60 for receiving the electronic card 200 therein includes a rectangular base board 61, and a cover portion 62 protruded forward and then spread outward from a front end of the base board 61 and projecting beyond the front end of the base board 61. The cover portion 62 is corresponding to the opening 302 of the electronic device 300. Two opposite sides of the base board 61 are concaved inward to form two cavities 64 matching with the two elastic components 40. The base board 61 defines a receiving space 63 for receiving the electronic card 200 therein.

Referring to FIGS. 1-6, each of the conductive terminals 20 is integrally molded to the bottom wall 11 of the insulating housing 10 with the locating portion 21 being molded in the bottom wall 11, the contact portion 22 defined at a top thereof projecting beyond the bottom wall 11 through the first terminal hole 111 to electrically contact with the electronic card 200 and the soldering portion 23 defined at a rear thereof projecting under the bottom wall 11 through the second terminal hole 112 to be soldered on the circuit board. The two elastic components 40 are assembled to two opposite sides of the insulating housing 10. One elastic component 40 is disposed to the fastening groove 16 which is defined in the first side wall 12 of the insulating housing 10, and the other elastic component 40 is disposed to the fastening groove 16 which is defined in the second protruding block 132. Specifically, the fastening portions 41 and the resilient portions 42 of the two elastic components 40 are fastened to the fastening grooves 16 with the two clamping portions 421 projecting beyond the bottom wall 11 of the insulating housing 10 through two inner sides of the two fastening grooves 16. The switch terminal 43 is disposed to an inner side of the fastening groove 16 which is defined in the first side wall 12 of the insulating housing 10.

Then the ejection mechanism 30 is slidably disposed to one side of the insulating housing 10. A portion of the base body 311 is slidably disposed on the bottom wall 11 of the insulating housing 10. The first elastic element 32 is restrained between the base body 311 of the sliding block 31 and the rear wall 14 of the insulating housing 10. The guiding element 33 of which one end is fastened in the sliding block 31 and the other end is slidably defined in a front of one side of the insulating housing 10. Specifically, the other side of the base body 311 away from the blocking portion 312 is slidably disposed on the bottom wall 11 with the first guiding rib 316 of the sliding block 31 being slidably disposed to the first guiding groove 113 and the second guiding rib 317 of the sliding block 31 being slidably disposed to the second guiding groove 114. The blocking portion 312 and the pushing portion 313 are disposed on the bottom wall 11 of the insulating housing 10. The guiding block 315 is slidably disposed to the guiding hole 115, so a front surface of pushing portion 313 is flush with the front surface of the rear wall 14. One end of the first elastic element 32 is worn around the second fastening pillar 141 and abuts against the front surface of the rear wall 14, and the other end of the first elastic element 32 is worn around the third fastening pillar 318 and abuts against a rear surface of the base body 311 of the sliding block 31 to restrain the first elastic element 32 between the base body 311 of the sliding block 31 and the rear wall 14 of the insulating housing 10. The sliding block 31 is capable of being pushed forward under an elastic action of the first elastic element 32 until a front surface of the base body 311 abuts against the other side of a rear surface of the first protruding block 131 adjacent to the second side wall 13 and a front surface of the blocking portion 312 abuts against a rear surface of the second protruding block 132. One end of the guiding element 33 is inserted into the insertion hole 319 and the other end of the guiding element 33 is slidably disposed in tracking groove 133.

The reset mechanism 50 is disposed to a front of the insulating housing 10 with the base portion 511 located at a front thereof elastically projecting beyond a front surface of the insulating housing 10. A rear end of the resisting portion 51 is received in the receiving trough 17, a front end of the resisting portion 51 is slidably disposed to the holding groove 172 and projects beyond the front surface of the first side wall 12 of the insulating housing 10 or the front surface of the other side of the first protruding block 131 away from the second side wall 13, the second elastic element 52 is disposed to the receiving trough 17 and restrained between a front surface of the rear sidewall of the receiving trough 17 and a rear surface of the resisting portion 51. Specifically, the movement portion 512 of the resisting portion 51 is slidably disposed in the holding groove 172 and further projects into the receiving trough 17, the base portion 511 of the resisting portion 51 projects beyond two front surfaces of two sidewalls of the holding groove 172. The limiting portion 513 and the fourth fastening pillar 514 of the resisting portion 51 project into the receiving trough 17. One end of the second elastic element 52 is respectively worn around the first fastening pillar 171 and abuts against the front surface of the rear sidewall of the receiving trough 17, and the other end of the second elastic element 52 is worn around the fourth fastening pillar 514 and abuts against a rear surface of the limiting portion 513 of the resisting portion 51. The resisting portion 51 is capable of being pushed forward under an elastic action of the second elastic element 52 until a front surface of the limiting portion 513 abuts against a rear surface of a front sidewall of the receiving trough 17.

The shielding shell 70 is covered on the insulating housing 10 to form an insertion space 80 between the insulating housing 10 and the shielding shell 70 for receiving the electronic card 200 therein. The contact portions 22 of the conductive terminals 20 and the two clamping portions 421 of the two elastic components 40 project into the insertion space 80.

The card tray 60 is slidably disposed to the insulating housing 10 of the card connector 100 from the opening 302 of the electronic device 300. When the card tray 60 is completed being assembled to the insulating housing 10, a rear surface of the base board 61 abuts against the front surface of the pushing portion 313 of the sliding block 31 and the front surface of the rear wall 14. The two clamping portions 421 of the two elastic components 40 are elastically received in the two cavities 64. The resisting portion 51 is pushed forward under the elastic action of the second elastic element 52 until the front surface of the limiting portion 513 abuts against the rear surface of the front sidewall of the receiving trough 17 so as to make a front surface of the base portion 511 abut against a rear surface of the cover portion 62 of the card tray 60. When the card connector 100 is mounted to the circuit board of the electronic device 300 to be assembled in the electronic device 300 to a proper position, the front surface of the base portion 511 of the reset mechanism 50 abuts against a rear surface of the enclosure 301 of the electronic device 300 so as to make a front surface of the cover portion 62 of the card tray 60 flush with an outer surface of the electronic device 300. The soldering portions 23 of the conductive terminals 20 are soldered on the circuit board of the electronic device 300.

Referring to FIGS. 1-5, when the electronic card 200 needs to be inserted in the card connector 100, the card tray 60 is pulled out of the insertion space 80 to place the electronic card 200 in the receiving space 63 of the card tray 60. Push the cover portion 62 of the card tray 60 rearward to make the card tray 60 together with the electronic card 200 be pushed rearward into the insertion space 80 of the card connector 100. In the process of the card tray 60 together with the electronic card 200 being pushed rearward into the insertion space 80 of the card connector 100, two opposite sides of the base board 61 press against the two clamping portions 421 to compress the two resilient portions 42 of the two elastic components 40 to generate elastic deformations, the rear surface of the cover portion 62 abuts against the front surface of the base portion 511, at the moment, the second elastic element 52 is compressed to accumulate an elastic potential energy. The rear surface of the base board 61 pushes against the front surface of the pushing portion 313 of the sliding block 31 so as to push the sliding block 31 to move rearward along the first guiding groove 113, the second guiding groove 114 and the guiding hole 115. The first elastic element 32 is compressed and accumulates the elastic potential energy, the guiding element 33 moves rearward along the tracking groove 133.

The card tray 60 goes on moving rearward until the rear surface of the base board 61 of the card tray 60 abuts against the front surface of the rear wall 14. Release the card tray 60, the first elastic element 32 rebounds to elastically push the sliding block 31 to slide forward, one end of the guiding element 33 slidably located in the tracking groove 133 is slid in the tracking groove 133 until one end of the guiding element 33 resists against the locking portion 134. The card tray 60 together with the electronic card 200 therein presses against the two clamping portions 421 of the two elastic components 40 with the elastic component 40 disposed to the fastening groove 16 which is defined in the first side wall 12 of the insulating housing 10 contacts the switch terminal 43 until the two clamping portions 421 of the two elastic components 40 are elastically received in the two cavities 64 of the card tray 60. The second elastic element 52 elastically pushes against the resisting portion 51 to move forward, the base portion 511 of the resisting portion 51 pushes the cover portion 62 of the card tray 60 to move forward until an upper portion and a lower portion of the front surface of the base portion 511 abuts against the rear surface of the enclosure 301 of the electronic device 300 so as to make the front surface of the cover portion 62 of the card tray 60 flush with the outer surface of the electronic device 300. The card tray 60 together with the electronic card 200 therein is locked in the card connector 100. So the card tray 60 together with the electronic card 200 therein is fully inserted in the card connector 100. Conductive portions of the electronic device 300 electrically contact the contact portions 22 of the conductive terminals 20 to realize an electrical connection between the electronic card 200 and the electronic device 300. The elastic component 40 disposed to the fastening groove 16 which is defined in the first side wall 12 of the insulating housing 10 departs from the switch terminal 43.

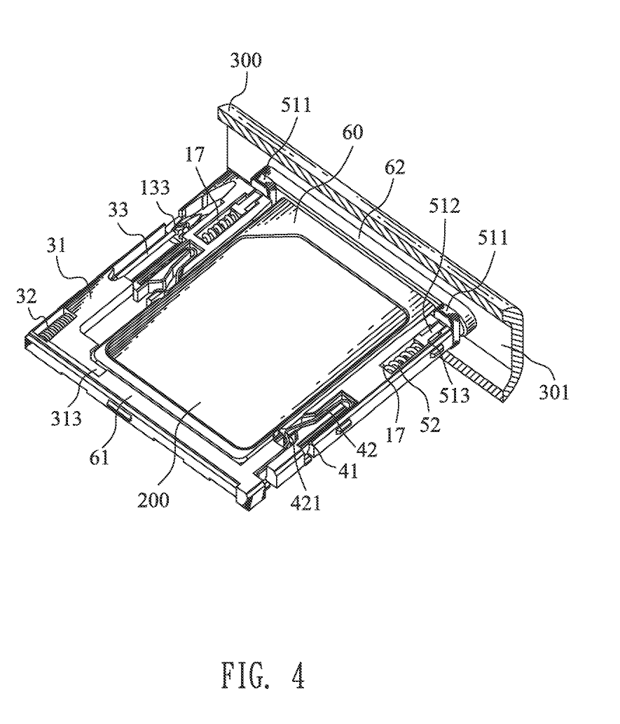

Referring to FIG. 2, FIG. 4, FIG. 5 and FIG. 6, when the electronic card 200 needs to be withdrawn from the card connector 100, pushes rearward the cover portion 62 of the card tray 60, the base board 61 of the card tray 60 pushes the sliding block 31 to slide rearward, one end of the guiding element 33 slidably located in the tracking groove 133 breaks away from the locking portion 134. Then release the card tray 60, the first elastic element 32 rebounds to elastically push the ejection mechanism 30 to slide forward along the first guiding groove 113, the second guiding groove 114 and the guiding hole 115 until the front surface of the base body 311 resists against the rear surface of the first protruding block 131 and the front surface of the blocking portion 312 resists against the rear surface of the second protruding block 132, at the same time, the base board 61 of the card tray 60 is pushed to move forward by virtue of the pushing portion 313 of the ejection mechanism 30, the two clamping portions 421 of the two elastic components 40 deviate from the two cavities 64 of the card tray 60, the card tray 60 together with electronic card 200 therein presses against the two clamping portions 421 of the two elastic components 40 with the elastic component 40 disposed to the fastening groove 16 which is defined in the first side wall 12 of the insulating housing 10 contacts the switch terminal 43 until the front surface of the base body 311 resists against the rear surface of the first protruding block 131 and the front surface of the blocking portion 312 resists against the rear surface of the second protruding block 132 to make the card tray 60 together with the electronic card 200 therein break away from the elastic component 40 disposed to the fastening groove 16 which is defined in the first side wall 12 of the insulating housing 10. A front end of the card tray 60 projects beyond the front surface of the enclosure 301 of the electronic device 300. The card tray 60 is pulled out of the card connector 100, the electronic card 200 is taken out from the receiving space 63 of the card tray 60 conveniently. The elastic component 40 disposed to the fastening groove 16 which is defined in the first side wall 12 of the insulating housing 10 departs from the switch terminal 43.

As described above, the card connector 100 includes at least one reset mechanism 50 which includes the base portion 511 located at the front thereof elastically projecting beyond the front surface of the insulating housing 10, when the card connector 100 is mounted to the circuit board of the electronic device 300 to be assembled in the electronic device 300 to the proper position, the front surface of the base portion 511 abuts against the rear surface of the enclosure 301 of the electronic device 300 so as to make the front surface of the cover portion 62 of the card tray 60 be flush with the outer surface of the electronic device 300. Therefore, it effectively improves an appearance of the electronic device 300.

What is claimed is:

1. A card connector adapted for being assembled in an electronic device which includes a circuit board and an enclosure, and being communicated between an electronic card and the circuit board, the enclosure defining an opening, the card connector comprising:
an insulating housing having a bottom wall, a first side wall and a second side wall extending upward from two opposite sides of the bottom wall, and a rear wall extending upward from a rear end of the bottom wall and connecting with the first side wall and the second side wall;
a plurality of conductive terminals of which each integrally molded to the bottom wall of the insulating housing with a contact portion thereof defined at a top thereof projecting beyond the bottom wall to electrically contact with the electronic card and a soldering portion defined at a rear thereof projecting under the bottom wall to be soldered on the circuit board;
at least one ejection mechanism slidably disposed to one side of the insulating housing, the ejection mechanism including a sliding block which includes a base body of which a portion slidably disposed on the bottom wall of the insulating housing, a first elastic element restrained between the base body of the sliding block and the rear wall of the insulating housing, and a guiding element of which one end is fastened in the sliding block and the other end is slidably located in a front of one side of the insulating housing, the sliding block having a blocking portion extended sideward from a rear end of one side of the base body, and a pushing portion extended sideward from a rear end of an outer side surface of the blocking portion, the blocking portion and the pushing portion being disposed on the bottom wall of the insulating housing;
at least one reset mechanism disposed to a front of the insulating housing with a base portion located at a front thereof elastically projecting beyond a front surface of the insulating housing;
a shielding shell covered on the insulating housing to form an insertion space between the insulating housing and the shielding shell for receiving the electronic card therein; and
a card tray slidably disposed to the insulating housing from the opening of the electronic device, the card tray for receiving the electronic card therein including a base board, and a cover portion protruded forward and then spread outward from a front end of the base board and projecting beyond the front end of the base board, the cover portion being corresponding to the opening of the electronic device;
wherein when the card connector is mounted to the circuit board of the electronic device to be assembled in the electronic device to a proper position, a front surface of the base portion of the reset mechanism abuts against a rear surface of the enclosure of the electronic device so as to make a front surface of the cover portion of the card tray be flush with an outer surface of the electronic device.

2. The card connector as claimed in claim 1, wherein a front end of one side of a top surface of the bottom wall of the insulating housing protrudes upward to form a first protruding block adjacent to the second side wall, a front end of a top surface of the first side wall of the insulating housing and the other side of the first protruding block away from the second side wall are concaved inward to form two receiving troughs, two middles of the two receiving troughs extend forward to form two holding grooves respectively passing through a front surface of the first side wall of the insulating housing and a front surface of the other side of the first protruding block away from the second side wall, the card connector includes two reset mechanisms of which each includes a resisting portion and a second elastic element, a rear end of the resisting portion is received in the receiving trough, a front end of the resisting portion is slidably disposed to the holding groove and projects beyond the front surface of the first side wall of the insulating housing or the front surface of the other side of the first protruding block away from the second side wall, the second elastic element is disposed to the receiving trough and restrained between a front surface of a rear sidewall of the receiving trough and a rear surface of the resisting portion.

3. The card connector as claimed in claim 2, wherein the rear sidewall of the receiving trough protrudes forward to form a first fastening pillar, the resisting portion has a base portion, a movement portion protruded rearward from a rear surface of the base portion, a limiting portion protruded outward from two opposite side surfaces and a bottom surface of a rear end of the movement portion, and a fourth fastening pillar protruded rearward from a rear surface of the movement portion, the movement portion of the resisting portion is slidably disposed in the holding groove and further projects into the receiving trough, the base portion of the resisting portion projects beyond two front surfaces of two sidewalls of the holding groove, the limiting portion and the fourth fastening pillar of the resisting portion project into the receiving trough, one end of the second elastic element is respectively worn around the first fastening pillar and abuts against the front surface of the rear sidewall of the receiving trough, and the other end of the second elastic element is worn around the fourth fastening pillar and abuts against a rear surface of the limiting portion of the resisting portion.

4. The card connector as claimed in claim 1, wherein the card connector further includes two elastic components assembled to two opposite sides of the insulating housing, two opposite sides of the base board of the card tray are concaved inward to form two cavities matching with the two elastic components.

5. The card connector as claimed in claim 4, wherein a front end of one side of a top surface of the bottom wall of the insulating housing protrudes upward to form a first protruding block adjacent to the second side wall, one side of a rear surface of the first protruding block away from the second side wall protrudes rearward to form a second protruding block, the insulating housing defines two lying U-shaped fastening grooves of which one penetrates through a top surface, two portions of an outer surface and an inner surface of the rear end of the first side wall of the insulating housing, and the other one penetrates through a top surface, a rear surface and an inner side surface of the second protruding block, the elastic component has a fastening portion fastened to the fastening groove and a resilient portion arched forward and then extended rearward from a front end of the fastening portion to be fastened to the fastening groove, a middle of the resilient portion is arched outward to form an arc-shaped clamping portion projecting beyond the bottom wall of the insulating housing to be elastically received in the two cavities.

6. The card connector as claimed in claim 1, wherein two portions of a rear end of one side of a top surface of the bottom wall of the insulating housing are concaved downward to form a first guiding groove and a second guiding groove, the sliding block has an extending portion extended opposite to the blocking portion from a front end of the other side surface of the base body, a bottom surface of the extending portion protrudes downward to form a first guiding rib, one side of a bottom surface of the base body adjacent to the blocking portion protrudes downward to form a second guiding rib, the other side of the base body away from the blocking portion is slidably disposed on the bottom wall of the insulating housing with the first guiding rib being slidably disposed to the first guiding groove and the second guiding rib being slidably disposed to the second guiding groove.

7. The card connector as claimed in claim 1, wherein the bottom wall of the insulating housing defines a guiding hole, a bottom surface of the pushing portion protrudes downward to form a guiding block, the guiding block is slidably disposed to the guiding hole.

8. The card connector as claimed in claim 1, wherein the base board of the card tray defines a receiving space for receiving the electronic card therein.

9. The card connector as claimed in claim 1, wherein a front end of one side of a top surface of the bottom wall of the insulating housing protrudes upward to form a first protruding block adjacent to the second side wall, one side of the first protruding block adjacent to the second side wall defines a substantially heart-shaped tracking groove joined end to end, a front end of the base body of the sliding block defines a locating groove penetrating through a top and a front thereof, a bottom sidewall of the locating groove defines an insertion hole, one end of the guiding element is inserted into the insertion hole and the other end of the guiding element is slidably disposed in tracking groove.

10. The card connector as claimed in claim 1, wherein the insulating housing defines two lying U-shaped fastening grooves of which one penetrates through a top surface, two portions of an outer surface and an inner surface of the rear end of the first side wall of the insulating housing, the card connector further includes two elastic components and a switch terminal, the switch terminal is disposed to an inner side of the fastening groove which is defined in the first side wall of the insulating housing, one elastic component is disposed to the fastening groove which is defined in the first side wall of the insulating housing to contact or depart from the switch terminal.
